(19) United States
(12) Patent Application Publication
(10) Pub. No.: US 2010/0045046 A1
(43) Pub. Date: Feb. 25, 2010

(54) FORCE FLUID FLOW ENERGY HARVESTER

(76) Inventor: Joel S. Douglas, Groton, CT (US)

Correspondence Address: MICHAUD-Kinney Group LLP, 306 INDUSTRIAL PARK ROAD, SUITE 206, MIDDLETOWN, CT, 06457, US

(21) Appl. No.: 12/546,943

(22) Filed: Aug. 25, 2009

Related U.S. Application Data
(60) Provisional application No. 61/091,541, filed on Aug. 25, 2008.

(51) Int. Cl. F03B 13/00; H02J 7/34

(52) U.S. Cl. 290/54; 320/101

(57) ABSTRACT

A reaction energy harvester capable of providing motion from fluid flow, including a foil/wing capable of being rotated to present the foil/wing so that the maximum lift is generated. The lift is created by the fluid flowing past the foil/wing. A channel or system may be provided to direct the fluid flow to the foil/wing. The rotating foil/wing configuration is integrated into a mechanical device which is designed to transfer the lift into a mechanical motion to drive a generator. The mechanical motion due to the created lift is reversed by using a stalling mechanism and counter balanced mechanism. This creates a bidirectional motion which can be captured and used to drive a generator. The device can be utilized in either air or hydraulic environments. A modification of the energy harvester can be configured to utilize the electricity generated to produce hydrogen for use in fuel cells or for combustion.

### CROSS REFERENCE TO RELATED APPLICATIONS

This application claims priority to U.S. Provisional Patent Application Ser. No. 61/091,541 “Fluid Flow Energy Harvester” in the name of Joel S. Douglas filed Aug. 25, 2008, contents of the foregoing application being incorporated herein by reference in their entirety.

### TECHNICAL FIELD

This invention relates to a device for harvesting energy and more specifically to an energy harvester that extracts energy from fluid flow by exploiting the lift created by the flow as it passes a hydrofoil or air foil. The device can be used with hydro-pneumatic, hydro, wind, or wave power systems.

### BACKGROUND

Hydropower systems are used for generating power from the tidal or current motion of water in oceans, bays, and rivers. Typically, such systems require a high water head and high flow conditions. System operating requirements that include both a larger water head and high flow conditions limit the suitable sites for locating fluid flow energy harvesters. Conventional hydro turbine technology, which involves positioning a powerhouse in a dam body with turbines located below the lowest water level, has been applied at mountain river and waterfall sites where a large water head can be developed. Consequently, powerhouses using hydro turbines are generally installed in large and complicated dam structures capable of withstanding the enormous water pressures generated. On the other hand, the hydro energy potential of thousands of rivers, streams, and canals remain untapped because hydro turbines, as an economical and practical matter, do not operate effectively with a low water head, in other words, when water level differences are about three meters or less. Such conventional hydro turbines need significant water depth for installation and cost-efficient operation.

Systems have also been developed to generate power using lower water head. These systems are described in U.S. Pat. Nos. 4,717,832; 5,074,710; and 5,222,833. The disclosures of which are incorporated herein by reference.

Systems for utilizing tidal motion and current flow of oceans and rivers are also known. Such systems usually require a dam or other physical structure that separates one part of a water body from another part. A difference in water levels is thereby created which provides a pressure differential useful for driving mechanical devices such as hydro turbine generators.

Also, axial-flow turbine type devices deriving power from liquid flow in tidal runs and stream beds are known. Such devices are disclosed in U.S. Pat. No. 3,980,894 to P. Vary et al., U.S. Pat. No. 3,986,787 to W. J. Mouton, Jr., U.S. Pat. No. 4,384,212 to J. M. Lapeyre, U.S. Pat. No. 4,412,417 to D. Dementhon, and U.S. Pat. No. 4,443,708 to J. M. Lapeyre.

Pivotal flow-modifying means is shown in the above Mouton, Jr. patent in a multiple unit embodiment.

U.S. Pat. No. 4,465,941 to E. M. Wilson discloses a water-wheel type device for the purpose of flow control pivotal valves or deflectors.

Additionally, various hydrofoil and air foil effect generating systems have been envisioned. The hydrofoil or airfoil effect is a physical phenomenon in which an object creates a current of fluid about itself. To avoid flow-detachment and “stall,” the leading edge of an airfoil must be rounded, which is a problem with many prior inventions. To produce flow-deflection as well as the “circulation” required for lift, the trailing edge of an airfoil must be fairly sharp. If a round leading edge and a sharp trailing edge are needed, then an airfoil must look like a streamlined teardrop shape.

In order to produce a lifting force, a foil must induce “circulation” by deflecting fluid downwards from its trailing edge. Because of this downwards deflection, fluid in front of the leading edge will be deflected upwards at the same time.

There are two ways to accomplish this deflection of fluid: 1. Tilt the entire foil at a positive angle of attack with respect to the oncoming fluid. 2. Give the foil an arch shape, so it's curved upwards in the center. This curve is called “camber.” Notice that the trailing edge of a cambered airfoil is tilted downwards. Because of this downwards tilt, the fluid will flow downwards off the trailing edge. The cambered shape also acts to prevent stall because the leading edge is tilted downwards to intercept the up flowing fluid. The end result is a foil with a streamlined teardrop shape which is bent upwards in the center.

Whenever the trailing edge of an airfoil causes fluid to move downwards, two other things occur. First, the fluid ahead of the foil will move upwards. Second, the fluid above the foil will speed up, and the fluid below the foil will slow down. Each fast-moving parcel of fluid above the foil greatly outraces its counterpart flowing below. Fluid divided by the foil doesn't rejoin again; instead a narrow region of fast flowing fluid appears above the foil, and a wide region of slow fluid appears below. Because of “Bernoulli's Principle,” relatively fast fluid exerts less pressure than slow fluid. This difference in pressure above and below the foil will create an upward force, known as the “lifting force.” End result: if we know the velocity of the fluid above and below the wing, then we can calculate the difference in pressure and discover the value of lifting force.

A foil can only deflect fluid downwards if it applies a downward force to the fluid, and since parcels of fluid have mass, any downward acceleration of fluid must be injecting momentum into the fluid. If the fluid gains downward momentum, then the foil must gain upward momentum at the same rate. If fluid is forced downwards, then the foil must be forced upwards. These are the simple consequences of Newton's 2nd and 3rd laws: force equals mass multiplied by acceleration and each force being paired with an equal and opposite force. End result: if the pattern of velocity of fluid surrounding a foil is known, the momentum flow and the lifting force can be calculated. The foil works because it is tilted and the trailing edge deflects fluid downwards. It also works because the foil has a special shape; the angle of the trailing edge is caused by foil camber and foil angle.

Some inventors think that the upper surface of a wing must be longer than the lower surface. They also think that the parcels of fluid being divided by a wing must rejoin each other after the wing has passed by. Both of these ideas are wrong. First, the parcels of fluid do not rejoin; wind tunnel smoke-pulse photographs clearly show that no rejoining takes place unless the wing is tilted so it produces zero lifting force. In other words, fluid parcels are permanently split by the wing, and the greater the split, the more lift is produced. Second, the fluid above a wing greatly outraces the fluid below, and these two velocities correctly predict the lifting force via Bernoulli's equation. If instead the lengths of the upper and lower surfaces of a wing are compared, the difference in path length is too small. If the path length difference is used to try to calculate the lifting force, the answer will be too small by several times. This makes perfect sense of course: if fluid parcels never rejoin behind the wing, then it becomes pointless to measure the path differences.

Some of the prior art insist that a wing must be curved on top and flat below. Or in other words, wings must be cambered or they won't create lift. This idea is wrong as well. Un-cambered wings fly just fine, and are used on high-performance acrobatic aircraft. Also, any plane can fly upside-down, even if this means that the flat side of the foil is then positioned on top.

Some textbook diagrams show that fluid isn't deflected by a wing. Instead they show the fluid approaching the wing horizontally and leaving horizontally. This is wrong. In real wings the fluid curves upwards to meet the oncoming foil and it's deflected downwards by the foil's trailing edge. If fluid wasn't deflected like this, then the fluid above a foil would move as fast as the fluid below, and the lifting force would be zero. Additionally, fluid behind an actual wing will keep flowing downwards long after the wing has passed by. The fluid far ahead of the aircraft is undisturbed, but the fluid behind the aircraft contains a downwards-moving “wake.”

Pneumatically driven systems using turbine blades have also been developed. However, these systems normally use blades that rotate at high speeds. These rotating blades are problematic as any sizable foreign object encountered by the system can damage the blades, thereby compromising the structural integrity of the system. When the system utilizes the flow of air such as in the use of turbine blade aircraft, bird strikes can cause significant damage to the rotating blades, as can stones or other debris inadvertently or intentionally injected into the rotating blades. When the system is a water system, the injection of aquatic plants and animals as well as debris frequently found in waterways (e.g. chunks of wood) can also cause damage.

The majority of the systems envisioned by the aforementioned technologies utilize high speed rotating blades that are noisy, detrimental to both flora and fauna, and require dams that interfere with the motion of the flowing water. The systems that are utilized in these applications significantly obstruct sunlight, thereby detrimentally affecting aquatic plant life. These approaches are normally resisted by the surrounding communities due to the harm caused to flora and fauna and the damming of the body of water that negatively affects community activities. In some cases entire communities are required to relocate depending on area to be flooded. The damming and rerouting of water flow can also cause significant upstream destruction of wildlife habitats.

Low head and low flow hydraulic conditions are prevalent throughout the world. The US Department of Energy (DOE) has studied the amount of low head water sources available in the United States and has published the result of that study in the report DOE-ID-11263 entitled Feasibility Assessment of the Water Energy Resources of the United States for New Low Power and Small Hydro Classes of Hydroelectric Plants. The difficulty described therein is that there are no simple and easy methods to harness the energy from low head water sources.

Table 1 from the DOE report provides a summary of hydroelectric energy in the United States and shows that with regard to the low head/high power and all low power sources including unconventional and micro hydro sources, there is approximately 47,000 MW of power that is available for harvesting. Effectively harvesting this capacity would more than double the power currently generated by hydro sources in the United States alone.

| | Annual Mean Power (MW) | | | |
|---|---|---|---|---|
| | Total | Developed | Excluded | Available |
| Total Power | 289,741 | 35,429 | 88,761 | 165,551 |
| Total High Power | 229,794 | 34,596 | 76,864 | 118,334 |
| High Head/High Power | 157,772 | 33,423 | 55,464 | 68,885 |
| Low Head/High Power | 72,022 | 1,173 | 21,400 | 49,449 |
| Total Low Power | 59,947 | 833 | 11,897 | 47,217 |
| High Head/Low Power | 35,403 | 373 | 9,163 | 25,868 |
| Low Head/Low Power | 24,544 | 461 | 2,734 | 21,350 |
| Conventional Turbine | 8,470 | 319 | 899 | 7,253 |
| Unconventional | 3,932 | 43 | 527 | 3,362 |
| Turbine | | | | |
| Microhydro | 12,142 | 99 | 1,308 | 10,735 |

However, despite the technological efforts described previously, there is no known system capable of generating continuous electricity from low head/high power and low power sources—such as tidal and/or river flow—under changing flow conditions.

In view of the issues related to the current state of the art of fluid flow energy harvesters and the increasing demand for electricity, a need exists for a system that does not harm flora or fauna and can be introduced into the environment without interfering with the natural water flow. A need also exists for an environmentally friendly, quiet, efficient, and simple energy harvester that can operate in low head and low flow conditions.

### SUMMARY OF THE INVENTION

As used herein, the terms “hydro application” and “hydraulic” are used to describe the use of the energy harvesting device with regard to liquid, and the terms “gas application” and “pneumatic” are used to describe the use of the energy harvesting device with regard to gas (e.g. air).

As used herein, the term “lift” refers to a force that is perpendicular to the direction of fluid flow.

The present invention provides an energy harvesting device capable of generating energy from low power hydraulic or pneumatic flows using lift generated by Bernoulli's Principle, while taking advantage of the numerous sources of fluid flowing under low head pressure and/or flow velocities of 1 foot per second or greater. For hydro applications, gearing multiplication is not required. The energy harvester comprises inflow and outflow fluid channels, an energy harvester chamber, and a revolving foil/wing, which is typically mounted in a horizontal configuration and transversely to the direction of fluid flow. The inflow channel is provided with diverters and baffles to direct the flow of fluid to the foil/wing. Referring to FIG. 1, foil/wing C experiences lift force L, which is developed by turning the fluid flow that the foil/wing is immersed in so that the side of the foil/wing distal from the fluid flow direction has a lower pressure gradient and the opposing side has a higher pressure gradient thereby allowing the foil/wing to move from high pressure to low pressure. Directing the fluid to the foil/wing via the diverters and baffles increases the lift on the foil/wing. More specifically, the foil/wing experiences lift from the fluid flow moving in the positive X direction, which causes the foil/wing to move in the positive Y direction.

The lift can be transferred into a mechanical system, for example, it can be transferred to a generator via a driveshaft or a similar mechanism. This lift can also be harnessed to drive a reciprocating device.

If the flow is reversed and the foil/wing is manipulated to allow the foil/wing to pivot, the lift will be in the opposite direction.

For gas applications, the energy harvester applications are under ultra low head pressure fluid flow, and the energy harvester can readily deliver significant lift causing the system to drive a conventional industrial generator. This allows the energy harvester of the present invention to achieve efficiencies higher than energy harvesters of the prior art. For hydro applications, under ultra low head flow or any strong current of 1 foot per second or greater, a minimal gearing application is required, which is less than is needed for prior art energy harvesters. Also because the lift that is developed is dependent on the flow of the fluid (air or water) and the size of the foil/wing (FIG. 1), this makes for a very scalable application.

In the case of pneumatic energy conversion, the channel forces the air to be directed at the rotating foil/wing and delivers it so maximum lift is created. The energy captured in the flowing air is then converted to mechanical energy. Connection of the energy harvester to an electric generator allows for the generation of electrical energy. No additional gearing to increase the speed of the air energy harvester relative to the generator's speed is required.

In a hydro application embodiment, the energy harvester can be mounted in a self-floating configuration and attached to a vessel or platform located in a current of 1 foot per second or greater, such as in a tidal channel. In such an embodiment, the energy harvester is located just below the surface of the water, where the current velocity is greatest, and is retained in that location by virtue of the rise and fall of the vessel with the water. A housing to channel the flow to the energy harvester may be provided if desired, but is not necessary if the current velocity is sufficiently great. The energy harvester is connected to a suitable electric generator, which may be mounted on the vessel in a water tight chamber or remotely located. Since the energy harvester is located in the water, the lift is converted into mechanical energy to drive the generator.

Alternatively, the flow can be concentrated so that the speed of the fluid passing the foil/wing is accelerated to increase the lift of the foil/wing. Channeling the flow from a larger cross section into a smaller cross section where the foil/wing can take advantage of the increased flow speed facilitates an increase in the lift of the foil/wing. An alternative generator that could be used involves the placement of a magnet on the moving energy harvester such that the magnet passes through a coil to generate a current. This eliminates the need to have the motion converted into a rotary motion to drive a generator and increases the efficiency.

### BRIEF DESCRIPTION OF THE DRAWINGS

The invention will be more fully understood from the following detailed description taken in conjunction with the accompanying drawings in which:

FIG. 1 is a schematic representation of a foil/wing showing lift of the foil/wing relative to a fluid flow;

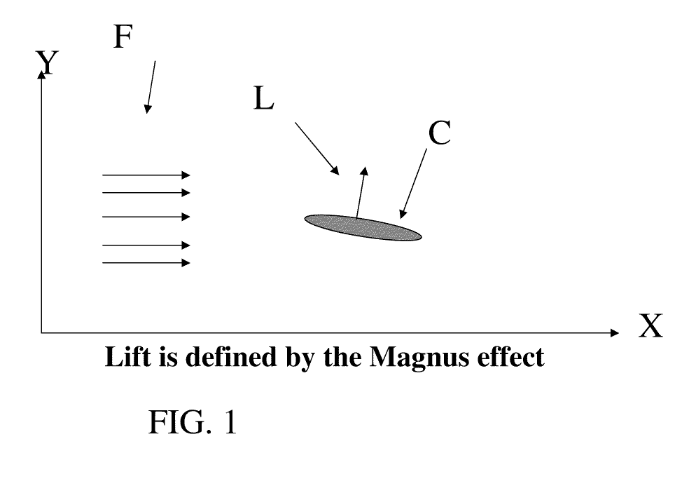

FIG. 2 is a schematic representation of a side view of an energy harvester in the down position;

FIG. 3 is a schematic representation of a side view of the energy harvester of FIG. 2 in the up position;

FIG. 4 is a schematic illustration of a top view of the energy harvester of FIG. 2;

FIG. 5 is a schematic illustration of a side view of an energy harvester that utilizes a magnet passing through a coil to generate electrical current.

FIG. 6 is a schematic illustration of a side view of a wind driven energy harvester in the down position;

FIG. 7 is a schematic illustration of a side view of the wind driven energy harvester of FIG. 6 in the up position;

FIG. 8 is a schematic illustration of the top view of the wind driven energy harvester of FIG. 6;

FIG. 9 is a schematic illustration of a side view of a hydraulic energy harvester designed for use in building piping systems in the down position;

FIG. 10 is a schematic illustration of a side view of the hydraulic energy harvester of FIG. 9 in the up position;

FIG. 11 is a schematic illustration of a top view of the hydraulic energy harvester of FIG. 9;

FIG. 12 is a block diagram of a process of producing energy from one or more reaction energy harvesters and transferring that energy to a power grid;

FIG. 13 is a block diagram of a process of transferring power from one or more reaction energy harvesters for producing hydrogen and oxygen;

FIG. 14 is a schematic illustration of a side view of an energy harvester with two foil/wings;

FIG. 15 is a schematic illustration of an end view of a hydraulic energy harvester assembly suspended from a catamaran for use with a fluctuating water level;

FIG. 16 is a schematic illustration of a side view of the assembly of FIG. 15;

FIG. 17 is a schematic illustration of a side view of a rotating generator; and

FIG. 18 is a schematic illustration of a top view of the rotating generator of FIG. 17.

### DETAILED DESCRIPTION OF THE PREFERRED EMBODIMENTS

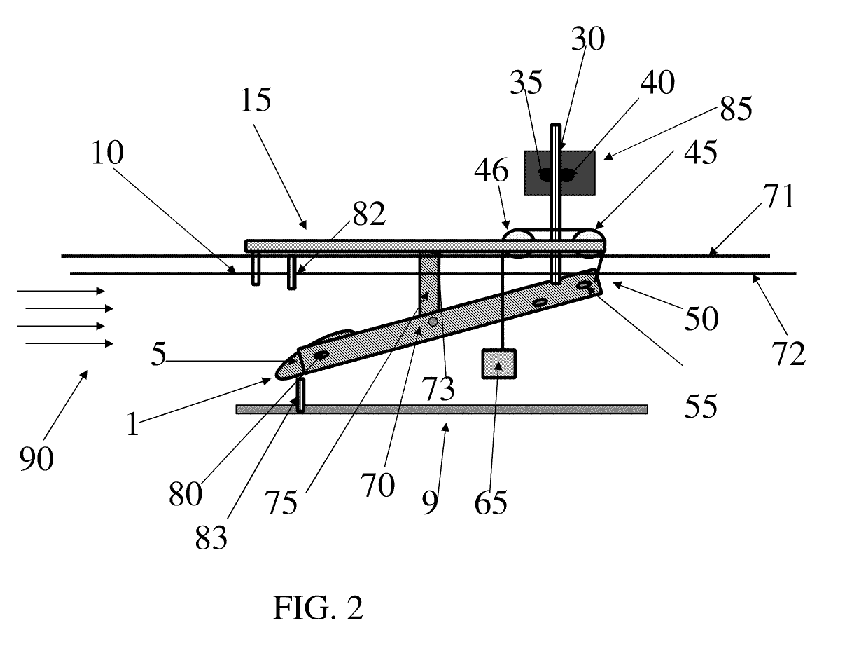

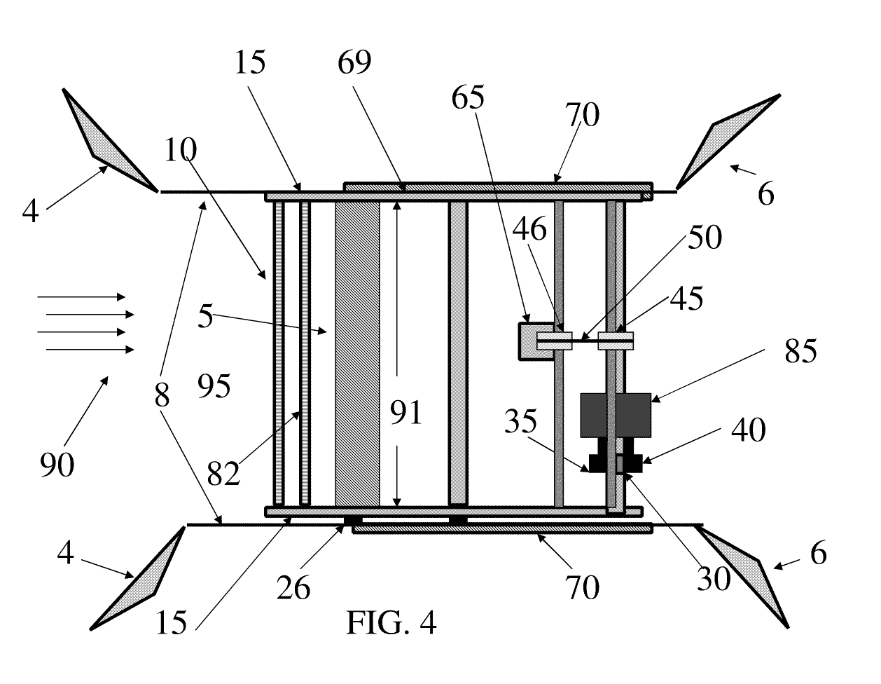

A reaction energy harvester 1 for use in hydraulic flows according to the present invention is shown in FIGS. 2, 3, and 4. The energy harvester comprises inflow fluid channel walls 4 (shown on FIG. 4), energy harvester channel side walls 8 that receive a flow 90 from the inflow channel walls 4, outflow fluid channel walls 6 that direct the flow from the channel side walls, and a foil/wing 5 mounted so it may rotate between the channel side walls. A stall baffle 10 is located downstream of the inflow fluid channel walls 4. The reaction energy harvester 1 also comprises top and bottom chamber walls and extend along the length of the foil/wing, like top and bottom walls that would be parallel to each other and perpendicular to the channel side walls 8 that can also be curved either in the side or top and bottom walls in this configuration and having opposite elevations in the plane parallel to a fluid flow path defined by the flow 90 through a channel formed at least in part by the inflow fluid channel walls 4, the outflow fluid channel walls 6, and the channel side walls 8. The elevations can be offset in the direction of rotation of the leading edge to rotatably channel fluid in the flow path and to direct fluid flow to the foil/wing with a radial component of flow relative to the foil/wing. This acts as a concentrator for the fluid flow, thereby increasing the speed of the fluid, which will increase the lift generated by the foil/wing. This intensification can be used in any of the embodiments envisioned by the present invention.

The foil/wing 5 is mounted inside the channel formed by a passage 95 formed by the opposed channel side walls 8, the inflow fluid channel walls 4, and the outflow fluid channel walls 6. This passage 95 directs the flow 90 through the energy harvester. The foil/wing 5 is oriented transversely to the flow 90 through the passage 95 and is mounted for rotation, for example, via bearings 80 in foil/wing supports 70.

The foil/wing 5 is driven in rotation about an axle held in the bearings 80 by being moved from position “A” to position “B” by cam 82 and 83 the Foil/wing 5 so that adequate rotation is provided to generate lift when the flow 90 is concentrated through the channel 95. This concentrating of fluid in the channel 95 accelerates the flow 90 by funneling the fluid towards the Foil/wing 5, thereby increasing the lift.

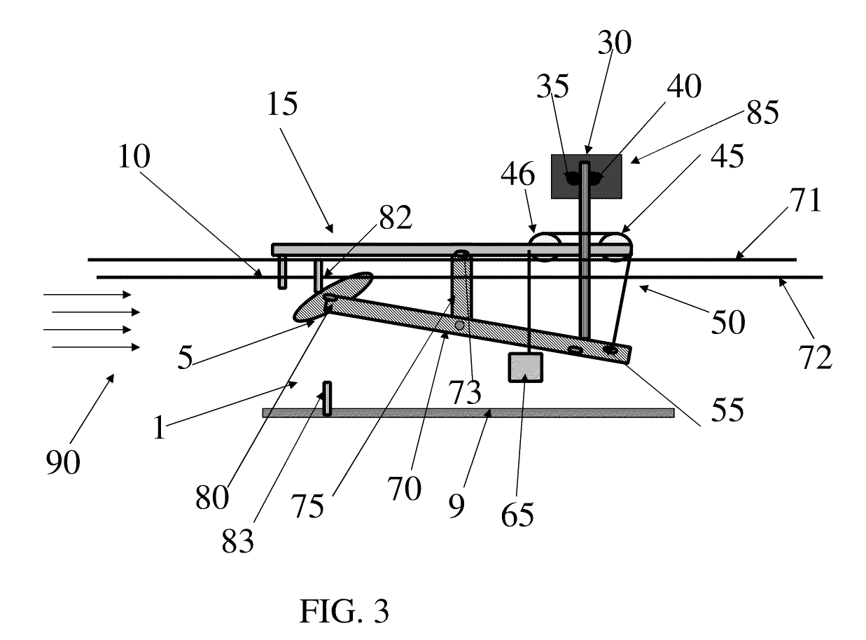

Referring specifically to FIGS. 2 and 3, fluid flow 90 in the direction as shown by the arrows and along the channel 95 causes lift to be exerted on the foil/wing 5, which pushes the foil/wing towards support 15 by rotating a frame 69 comprised of the foil/wing support 70 and a foil/wing support arm 75 about a pivot 73 in the direction up towards support 15. Rotation of the frame 69 about the pivot 73 causes the leading edge of the frame to rotate (up) toward the support 15 while correspondingly causing the trailing edge of the frame to rotate (down) in the direction away from the support. A counterbalancing system is defined at least in part by a counterweight 65 attached to the foil/wing support 70 by a pin 55 and a cable 50. The cable 50 is guided in pulleys 45 and 46 which are mounted to the walls of the flow chamber.

During operation of the reaction energy harvester 1, once the foil/wing 5 moves into a position behind the stall baffle 10 (relative to the direction of the flow 90), the flow is impeded and the cam 82 moves the foil/wing about bearing 80. The cam 82 combined with the impeded flow permits the stored energy in the counterweight 65 to return the frame 69 and the foil/wing 5 to the lower position cam 83 returns the foil/wing 5 so that lift is created in the opposite direction, thereby providing lift and starting the process over again. The present invention is not limited to the use of a counterweight to return the frame 69 to the lower position; however, rotation of the foil/wing by cam 82 can also drive the foil/wing 5 down into the lower position as shown in FIG. 3.

Power is extracted from the operation of the reaction energy harvester 1 on both the upward and the downward movements of the frame 69 via a rack 30 attached to the frame. When the frame 69 (and the foil/wing 5) is lifted, the rack 30 is driven so that one or more gears are rotated so power is extracted on the upstroke. When the frame 69 (and the foil/wing 5) is lowered, one or more gears are rotated so power is extracted on the down stroke.

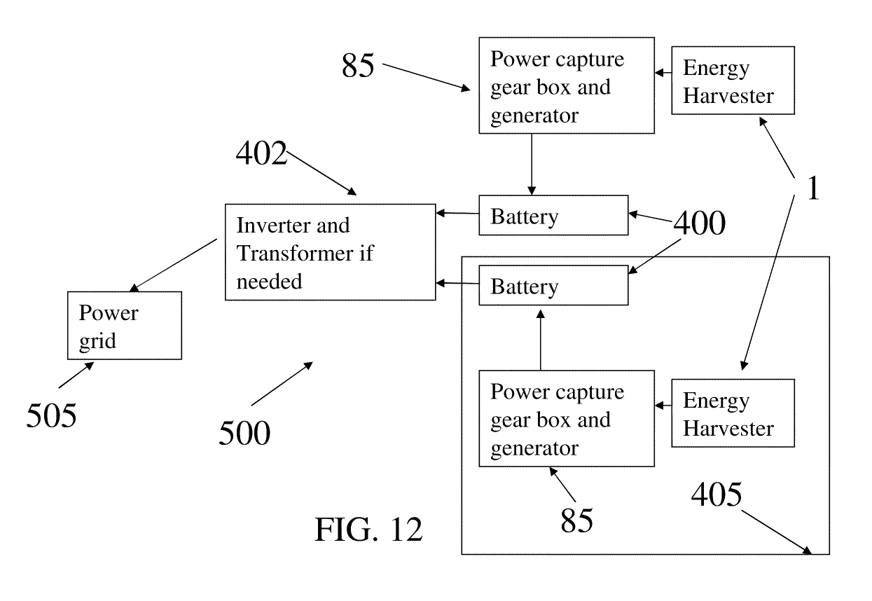

The rack 30 is a linear gear with teeth on two surfaces thereof. The teeth may be on opposing surfaces of the gear; however, the present invention is not limited in this regard as the teeth may be positioned on adjacent surfaces of the gear or even on the same surface of the gear. Movement of the rack 30 drives pinion gears 35 and 40, which in turn drive a power capture gear box and generator 85. The pinion gear 35 is clutched so that the power capture gear box and generator 85 is driven both on the down stroke and on the up stroke of the foil/wing 5. The power capture gearbox and generator 85 is electrically connected to a battery 400, as shown in FIG. 12, and the output of the generator is used to charge the battery. The electrical energy generated by the power capture gearbox and generator 85 is stored in the battery 400 until it is used by a network (e.g., a power grid) connected to the battery.

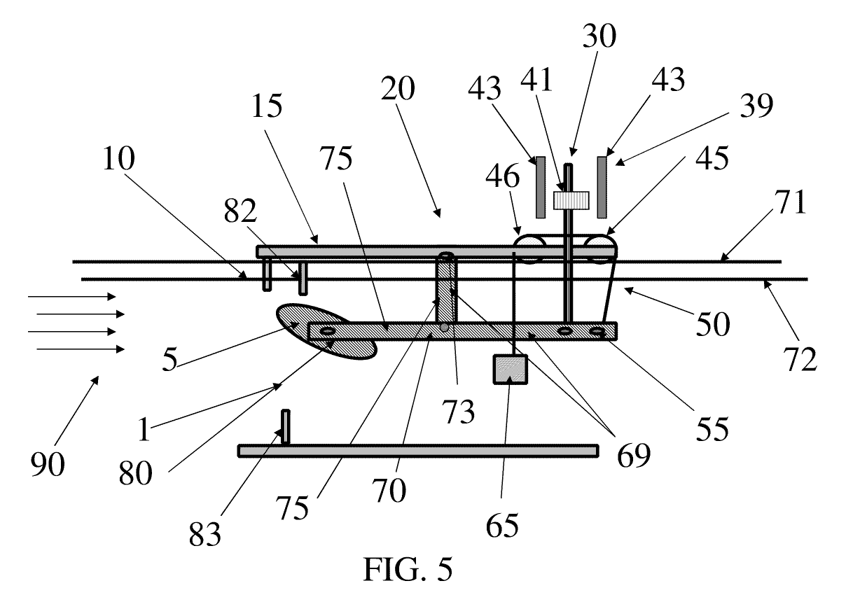

Referring now to FIG. 5, an alternative generator that could be used in any embodiment of the energy harvester is shown generally at 39. This generator 39 utilizes a magnet 41 placed on any suitable surface of the energy harvester 1, such as the foil/wing 5 as shown. The movement of the foil/wing 5 causes the magnet 41 to pass through a coil 43 to generate an electrical current. This eliminates the use of the gearbox and the conversion of the motion into a rotary motion to drive a generator and accordingly increases the efficiency.

In any embodiment, the counterweight 65 can be replaced with any balancing mechanism such as a hydraulic or pneumatic foil/wing, spring, or a reverse-oriented foil/wing which could be engaged to drive the forward-oriented foil/wing down by reversing the lift on the foil/wing to drive it in the opposite direction. In such an embodiment, the return foil/wing would be reversed by the cam 83 when the forward foil/wing is returned to the starting position.

In embodiments using a gearbox, an increase of force inputted into the capture gearbox and generator 85 means that a bigger generator could be driven. The amount of force required as input for the power capture gearbox and generator 85 can be achieved by the embodiments described herein by modifying various variables. Also, the size and cross sectional area of the foil/wing 5 can be increased to increase lift, thereby increasing speed which translates into increased force. Furthermore, the length (shown at 91 in FIG. 4) of the foil/wing 5 can be adjusted. The longer the length 91, the greater the lift produced from the flow, so by increasing the length 91, the force is increased. Moreover, the pivot point 73 as shown in FIGS. 2 and 3 can be moved on the frame 69 so that it is located more towards the pulley 45 on support 15. By moving the pivot point, an increased amount of force can be delivered to the power capture gearbox and generator 85. Also the pivot 73 could be relocated along arm 70 to result in a higher force being applied to the power capture gearbox and generator 85.

If the fluid flow 90 is reversed, similar to that found in a tidal basin where the tide comes in and goes out, the lift generated by the foil/wing 5 will be in the opposite direction desired. To generate power in both directions of flow 90, the foil/wing 5 can be reversed by changing the direction of the leading edge to maintain the lift in the same direction so as to drive the reciprocating mechanism so that it continues to create power.

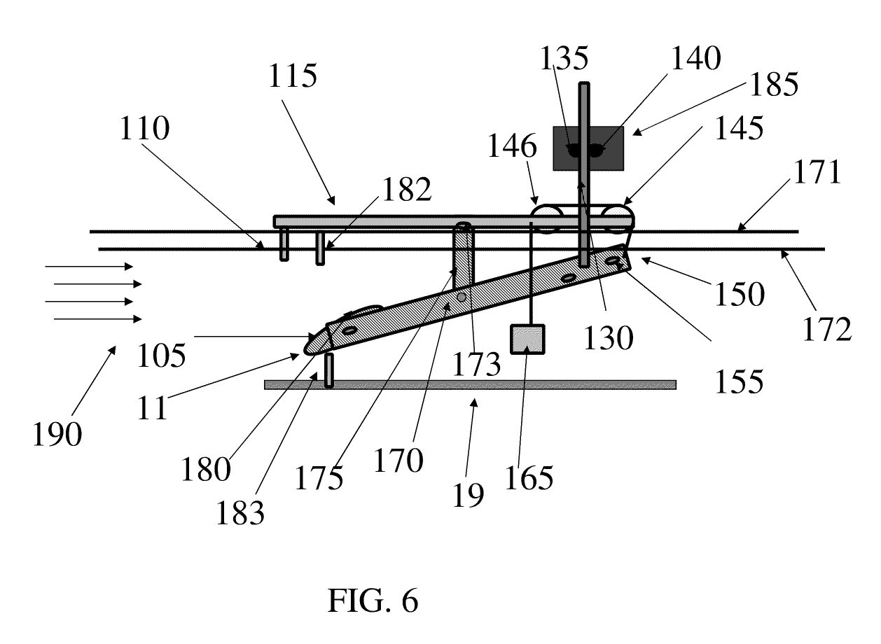

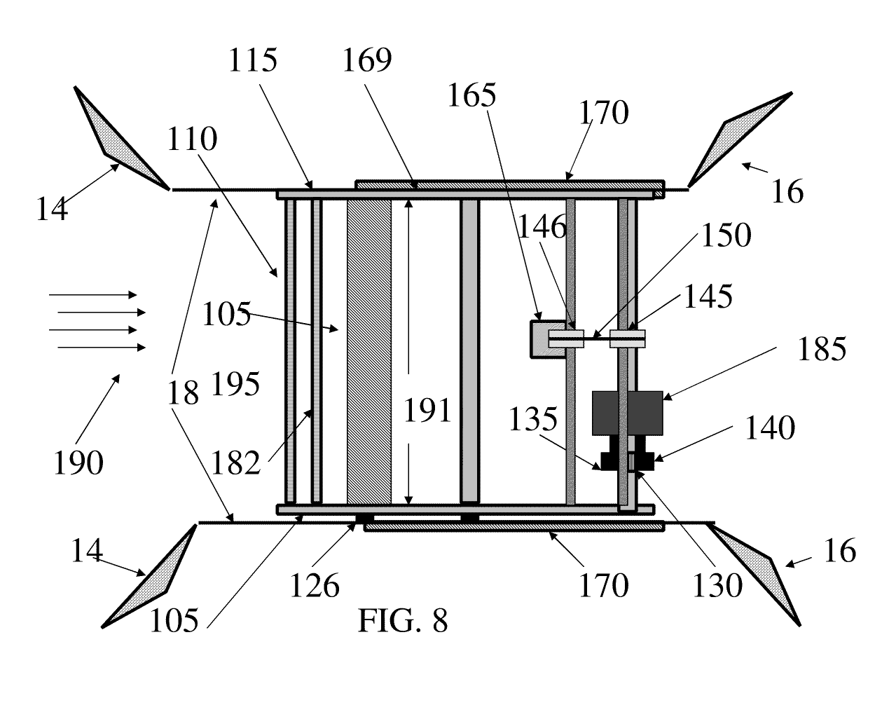

A reaction energy harvester 11 for use in air or pneumatic flows according to the present invention is shown in FIGS. 6, 7, and 8. The reaction energy harvester 11 comprises inflow and outflow fluid (shown on FIG. 8), and a working foil/wing 105. The foil/wing is mounted inside a passage 195 formed by the inflow fluid channels 14 and the channel side walls 18 or ductwork that approximates such structure. The outflow fluid channels 16 are located at the downstream end of this passage 195 to direct flow 190 out of the reaction energy harvester 11. The foil/wing 105 is oriented transversely to the flow 190 through the passage 195 and is mounted for rotation, for example, via bearings 180 in side supports 170.

The foil/wing 105 is driven by the fluid flow and the creation of lift. This generation of lift when the flow 190 is concentrated through the channel 195 creates motion which can be used to drive the generator. This concentrating of fluid in the channel 195 accelerates the flow by funneling the fluid towards the foil/wing 105, thereby increasing the lift.

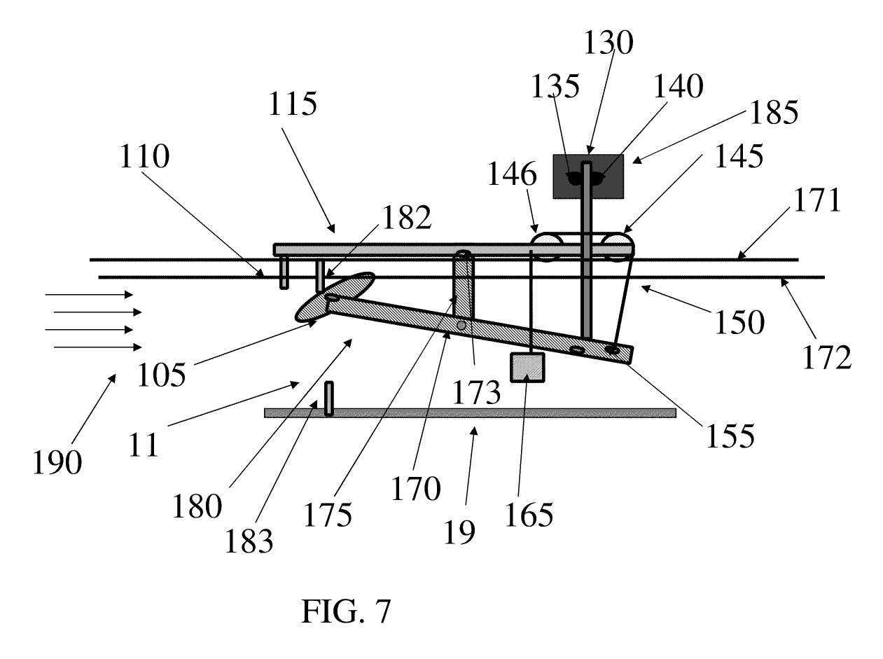

Referring to FIGS. 7 and 8, fluid flow 190 in the direction as indicated by the arrows, along the channel 195, causes the foil/wing 105 to raise up towards support 170 thereby rotating a frame 169 comprised of the foil/wing support 170 and a foil/wing support arm 175 about a pivot 173 in the direction up towards support 115. Rotation of the frame 169 about the pivot 173 causes the leading edge of the frame to rotate (up) toward the support 115 while correspondingly causing the trailing edge of the frame to rotate (down) in the direction away from the support. A counterweight 165 is attached to the foil/wing support 170 by a pin 155 and a cable 150. The cable 150 is guided in pulleys 145 and 146 rotatably mounted to the side walls of the channel. The cams 182 and 183 are used to change the leading edge direction of the foil/wing so that the lift direction is changed.

During operation of the reaction energy harvester 11, once the foil/wing 105 moves into a position behind the stall baffle 110 (relative to the direction of the flow 190), the flow is impeded and the cam 182 reverse the direction of the foil/wing to generate lift in the opposite direction. The resulting reverse flow combined with the impeded flow permits the stored energy in the counterweight 165 to return the frame 169 and the foil/wing 105 to the lower position where the cam 183 reverses the process and the foil/wing is driven up, thereby providing lift and starting the process over again. The present invention is not limited to the use of a counterweight 165 to return the frame 169 to the lower position, however, as the foil/wing 105 could be reversed to drive the frame 169 down into the lower position, as shown in FIG. 6.

Power is extracted from the operation of the reaction energy harvester 11 on both the upward and the downward movements of the frame 169 via a rack 130 attached to the frame. When the frame 169 (and the foil/wing 105) is lifted, the rack 130 is driven so that one or more gears are rotated so power is extracted on the upstroke. When the frame 169 (and the foil/wing 105) is lowered, one or more gears are rotated so power is extracted on the down stroke.

The rack 130 is a linear gear with teeth on two surfaces thereof. The teeth may be on opposing surfaces of the gear; however, the present invention is not limited in this regard as the teeth may be positioned on adjacent surfaces of the gear or even on the same surface of the gear. Movement of the rack 130 drives pinion gears 135 and 140, which in turn drive a power capture gear box and generator 185. The pinion gear 135 is clutched so that the power capture gear box and generator 185 is driven on the down stroke of the foil/wing 105, and the pinion gear 145 is clutched so that the power capture gear box and generator 185 is driven on the upstroke of the foil/wing 105. The power capture gearbox and generator 185 is electrically connected to a battery 400, as shown in FIG. 12, and the output of the generator is used to charge the battery. The electrical energy generated by the power capture gearbox and generator 185 is stored in the battery 400 until it is used by a network that it is linked into. An alternative generator that could be used is one in which a magnet is placed on the moving energy harvester 11 and passed through a coil so as to generate a current. This eliminates the conversion of the motion into a rotary motion to drive a generator and increases the efficiency. The counterweight 165 can be replaced with any balancing mechanism such as a hydraulic or pneumatic foil/wing, spring, or a reverse-oriented foil/wing which could be engaged to drive the forward-oriented foil/wing down when it is stopped. In such an embodiment, the return foil/wing would be stopped when the forward foil/wing is returned to the starting position.

An increase of force inputted into the capture gearbox and generator 185 means that a bigger generator could be driven. The amount of force required as input for the power capture gearbox and generator 185 can be achieved by the embodiments described herein by modifying variables such as position of the lift points or the size and shape of the foil/wing. When the foil/wing 105 size is increased the result is an increase in lift, thereby increasing speed, which translates into increased force. Furthermore, the length of the foil/wing 105 can be adjusted. The longer the length is, the greater the lift that is produced from the flow, so by increasing the length the force is increased. Moreover, the pivot point 173 as shown in FIGS. 6 and 7 can be moved on the frame 169 so that the pivot 173 is located on more towards the pulley 145 on support 115. By moving the pivot 173, an increased amount of force can be delivered to the power capture gearbox and generator 185.

If the fluid flow 190 is reversed similar to that found in a tidal basin where the tide comes in and goes out, the lift generated by the foil/wing 105 will be in the opposite direction desired. To generate power in both directions of flow 190, the foil/wing 105 can be reversed by changing the leading edge of foil/wing 105 to maintain the lift in the same direction, thereby driving the rack 130 so that power is generated.

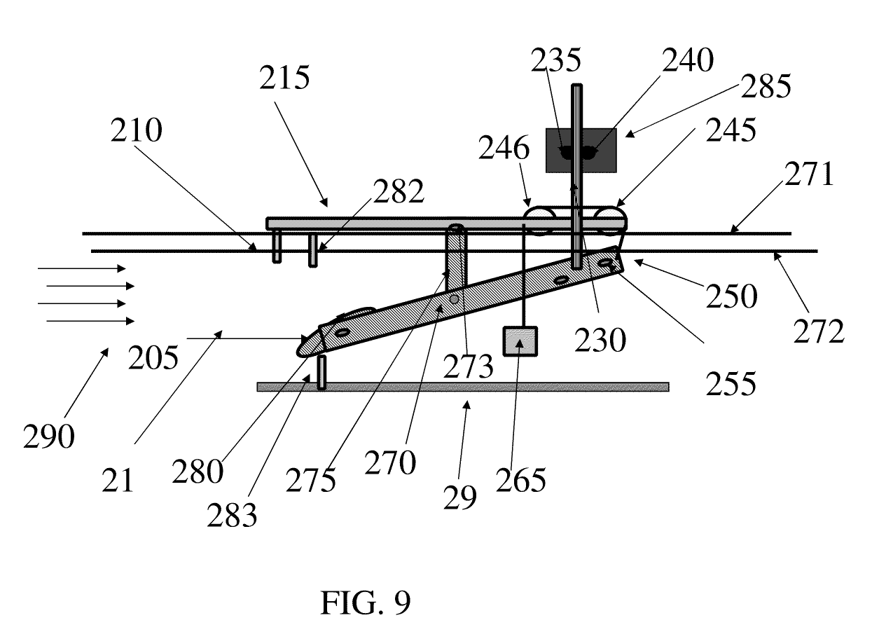

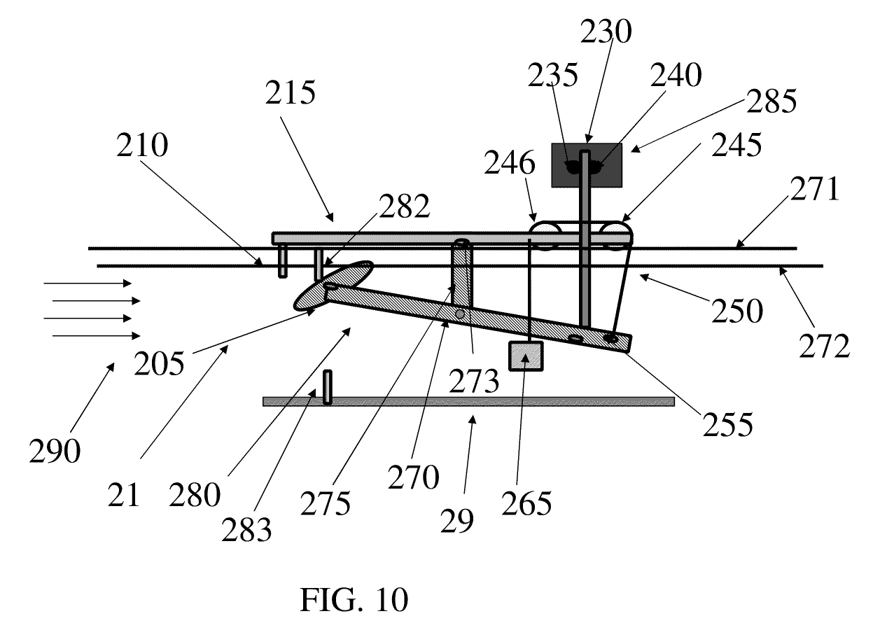

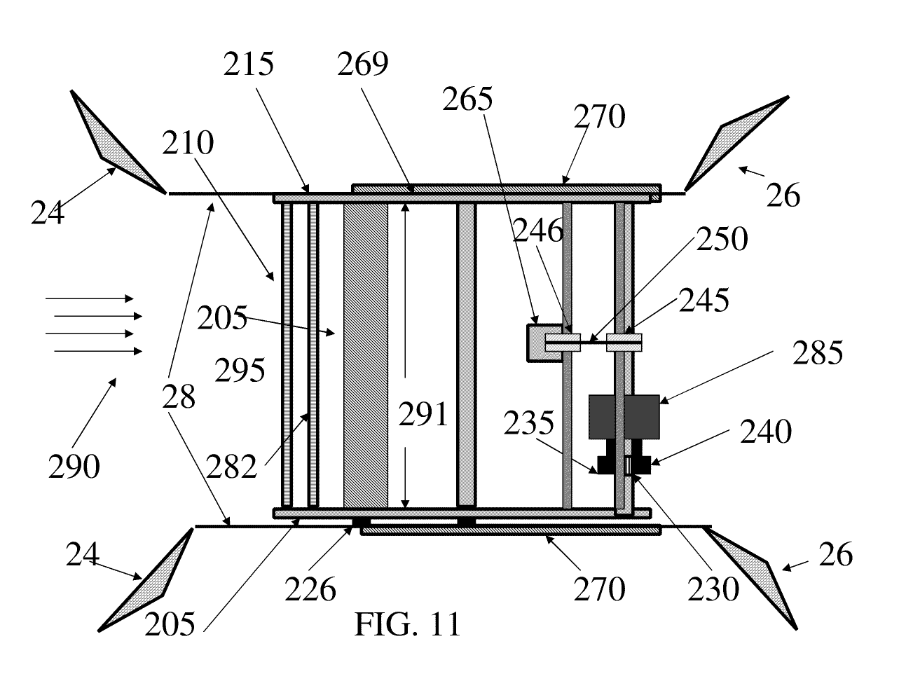

A reaction energy harvester 21 for use in building outflows such as effluent lines connected to sewers, roofing drains, air conditioning lines, and the like for either pneumatic or hydraulic flows according to the present invention is shown in FIGS. 9, 10, and 11. The reaction energy harvester 21 comprises inflow and outflow fluid channels 24, 26, channel side walls 28 (shown on FIG. 11), and a working foil/wing 205. The foil/wing 205 is mounted inside a passage 295 formed by the inflow fluid channels 24 and the channel side walls 28 or ductwork that approximates such structure. The outflow fluid channels 26 are located at the downstream end of this passage 295 to direct flow 290 out of the reaction energy harvester 21. The foil/wing 205 is oriented transversely to the flow 290 through the passage 295 and is mounted for rotation, for example, via bearings 280 in side supports 270.

The foil/wing 205 is driven in rotation about an axle held in bearings 280 by cams 282 and 283. These cams rotate the foil/wing 205 so that it provides adequate rotation to position the foil/wing to generate lift when the flow 290 is concentrated through the channel 295. This concentrating of fluid in the channel 295 accelerates the flow by funneling the fluid towards the foil/wing 205, thereby increasing the lift.

Referring to FIGS. 9, 10 and 11, fluid flow 290 in the direction as indicated by the arrows, along the channel 295, causes the foil/wing 205 to raise up towards support 270 thereby rotating a frame 269 comprised of the foil/wing support 270 and a foil/wing support arm 275 about a pivot 273 in the direction up towards support 215. Rotation of the frame 269 about the pivot 273 causes the leading edge of the frame to rotate (up) toward the support 215 while correspondingly causing the trailing edge of the frame to rotate (down) in the direction away from the support. A counterweight 265 is attached to the foil/wing support 270 by a pin.

During operation of the reaction energy harvester 21, once the foil/wing 205 moves into a position behind the stall baffle 210 (relative to the direction of the flow 290), the flow is impeded and the cam 282 reverses the direction of the foil/wing 205. The reversing of the foil/wing 205 combined with the impeded flow permits the stored energy in the counterweight 265 to return the frame 269 and the foil/wing 205 to the lower position where the cam 283 reverses the foil/wing 205, thereby providing lift and starting the process over again. The present invention is not limited to the use of a counterweight 265 to return the frame 269 to the lower position.

Power is extracted from the operation of the reaction energy harvester 21 on both the upward and the downward movements of the frame 269 via a rack 230 attached to the frame. When the frame 269 (and the foil/wing 205) is lifted, the rack 230 is driven so that one or more gears are rotated so power is extracted on the upstroke. When the frame 269 (and the foil/wing 205) is lowered, one or more gears are rotated so power is extracted on the down stroke.

The rack 230 is a linear gear with teeth on two surfaces thereof. The teeth may be on opposing surfaces of the gear; however, the present invention is not limited in this regard as the teeth may be positioned on adjacent surfaces of the gear or even on the same surface of the gear. Movement of the rack 230 drives pinion gears 235 and 240, which in turn drive a power capture gear box and generator 285. The pinion gear 235 is clutched so that the power capture gear box and generator 285 is driven on the down stroke of the foil/wing 205, and the pinion gear 245 is clutched so that the power capture gear box and generator 285 is driven on the upstroke of the foil/wing 205. The power capture gearbox and generator 285 is electrically connected to a battery 400, as shown in FIG. 12, and the output of the generator is used to charge the battery. The electrical energy generated by the power capture gearbox and generator 285 is stored in the battery 400 until it is used by the network that it is linked into.

An alternative generator that could be used is to place a magnet on the moving energy harvester 21 and pass it through a coil so as to generate a current, as described above. This eliminates the use of the gearbox and the conversion of motion into a rotary motion to drive a generator and increases the efficiency.

In any embodiment described herein, the counterweight 265 can be replaced with any balancing mechanism such as a hydraulic or pneumatic foil/wing, or a reverse-oriented foil/wing which could be engaged to drive the forward-oriented foil/wing down when it is stopped. In such an embodiment, the return foil/wing would be rotated in the opposite direction when the forward foil/wing is returned to the starting position.

An increase of force inputted into the capture gearbox and generator 285 means that a bigger generator could be driven. The amount of force required as input for the power capture gearbox and generator 285 can be achieved by the embodiments described herein by modifying various variables. The size and shape of the foil/wing 205 can be increased to increase lift, thereby increasing speed and which translates into increase force. Furthermore, the length of the foil/wing 205 can be adjusted. The longer the length is, the greater the lift that is produced from the flow, so by increasing the length the force is increased. Also the pivot could be relocated to result in a higher force being applied to the power capture gearbox and generator 285.

If the fluid flow 290 is reversed similar to that found in a tidal basin where the tide comes in and goes out, the lift generated by the foil/wing 205 will be in the opposite direction desired. To generate power in both directions of flow 290, the foil/wing 205 can be reversed by changing the leading edge of the foil/wing 205 to maintain the lift in the same direction so as to drive the mechanism so that it continues to create power.

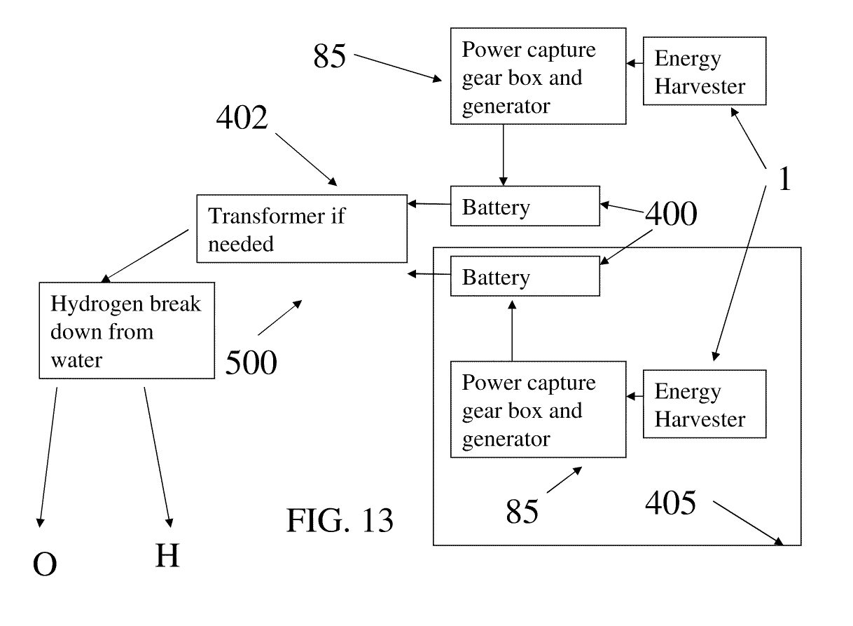

Referring now to FIG. 12, the process of producing energy from one or more reaction energy harvesters and transferring that energy to a power grid is shown generally at 500. In the process 500, the energy harvester 1 produces energy by mechanical pumping and driving the power capture gearbox and generator 85 which charges the battery 400. Process 500 is not limited to the incorporation of energy harvester 1 however, as any of the other energy harvesters and generators shown in FIGS. 2-11 may be utilized. Once the battery 400 is charged, it can be discharged to a power grid 505 by using an inverter and/or transformer 402 to adjust the output to the correct voltage. If the system utilizes more than one energy harvester they can be added to the battery charging side of the network as shown in an assembly 405 that comprises the energy harvester 1, the power capture gearbox and generator 85, and the battery 400. If direct current is required for power, then the inverter is not needed to transform direct current into alternating current and the transformer can be used to discharge the correct voltage as shown in FIG. 13. FIG. 13 also shows the power stored in batteries 400 used to create oxygen (O) and hydrogen (H) by breaking down water through electrolysis. The hydrogen or oxygen use individual outflow means such as a pipe to channel the gas so can be stored and used to power other energy producing devices such as fuel cells, stored for sale to others, used locally, or used in an internal combustion engine. The present invention is not limited in this regard, as the hydrogen and oxygen can be directed to other locations.

The energy harvester 1, 11 or 21 can be connected in any suitable manner to an electric generator 85, 39, 185 or 285 for generating electricity. The energy harvester could be connected to the generator by pulleys and cables, pulleys and belts, crank shafts, or other mechanical device(s) that convert reciprocating motion into rotary motion. Also the reciprocating motion could be used to generate electricity by using a linear motion generator similar to those designed by QM Power of Boston, Mass. This alternative generator is a magnet placed on the moving energy harvester (as described above), which passes through a coil to generate a current. This eliminates the conversion of linear motion into a rotary motion to drive a generator and increases the efficiency. More particularly, these devices take linear back and forth motion and generate DC or AC power depending on the desired output.

The energy harvester of the present invention is shown in FIGS. 2-11 in an application in which power may be generated from a water current flow having a sufficiently strong and, in many cases, reversible velocity of at least 1 foot per second. Using a configuration of the energy harvester as shown in FIG. 2, power may be generated in some tidal estuaries where there is no water head differential by reversing the rotation of the foil/wing 5 so as to generate lift from the foil/wing such that the lift rotates the frame 69 to rotate about the pivot 73 in the direction up towards support 15 with regard to the leading edge and down away from support 15 with regard to the trailing edge.

Any of the foregoing embodiments of the invention as described above can utilize a small motor to change the direction of the leading edge of the foil/wing 5, 105 or 205 such that the cams 82 and 83 are replaced with a motor drive to rotate the foil/wing 5, 105 or 205.

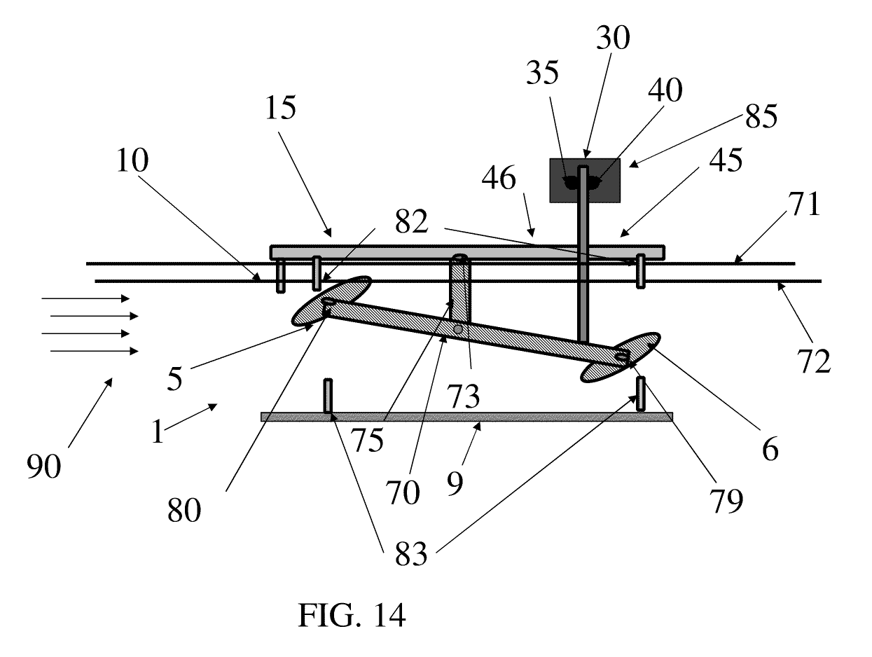

For added force, a second foil/wing 6 can be added to change the direction of the foil/wing support 70, generating power in both directions. Referring now to FIG. 14, during operation of the reaction energy harvester 1, once the foil/wing 5 moves into a position behind the stall baffle 10 (relative to the direction of the flow 90), the flow is impeded and the cam 82 moves the foil/wing about bearing 80. The cam 82 combined with the impeded flow deactivate the leading foil/wing 5 from producing further lift towards support 15. Simultaneously, cam 83 changes the orientation of the trailing foil/wing 6 about bearing 79, which is not impeded by stall baffle 10, so it produces lift to return foil/wing support 70 to its starting position.

The energy harvester 1 could be positioned from support 15 on each side of the energy harvester by attaching it to a bridge, an abutment, a floating barge, or building so that it is a self floating unit. When the energy harvester 1 is used in an effluent system that discharges to a sewer, holding lagoon, or other source, the energy harvester is submerged in the fluid flow. In one embodiment, the energy harvester is placed in a chamber in the effluent system that is specially designed to support the energy harvester.

In areas of flowing current such as a river or estuary, the velocity is greatest at the surface of the water and decreases to a minimum at the bottom. In a tidal estuary, the water level increases and decreases with the tides. In some areas, the water level fluctuations are substantial. In such areas, a fixed power generation installation cannot take advantage of the greatest velocity flow at the surface. To accommodate changes in water level fluctuations and the like, the reaction energy harvester 1 of the present invention may be installed on a vessel. The vessel rises and falls with the fluctuating water level to facilitate the positioning of the energy harvester at the most suitable location (e.g., at the position in which the fluid flow is of greatest velocity).

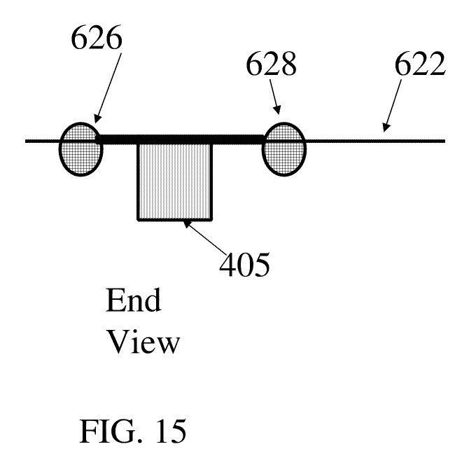

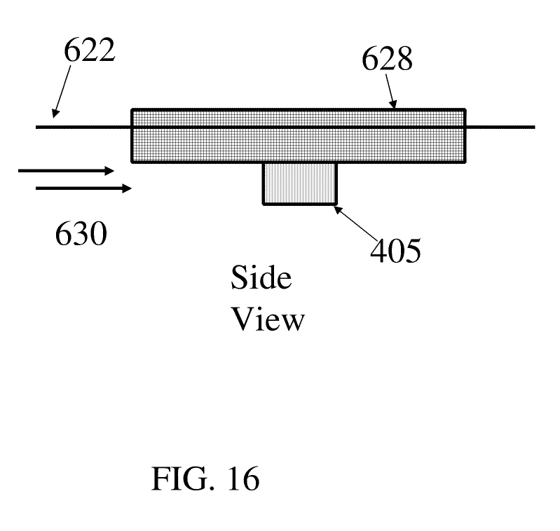

A floating catamaran installation is shown in FIGS. 15 and 16. The present invention is not limited to the use of a catamaran, however, as any type of vessel may be used. An energy harvester assembly 405 according to the present invention, such as described in reference to any of the embodiments described above, is mounted to extend between two pontoons or hulls 626, 628 of the catamaran and is oriented perpendicularly to the current flow, illustrated by arrows 630. The assembly 405 is mounted just below the surface of the water 622, so that the entire assembly is submerged. Water flows past the assembly 405 and power is generated as discussed above.

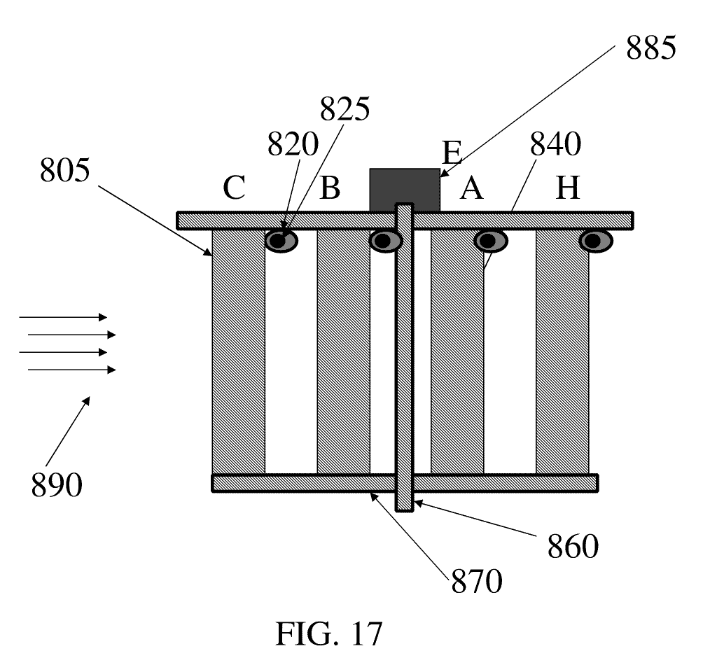

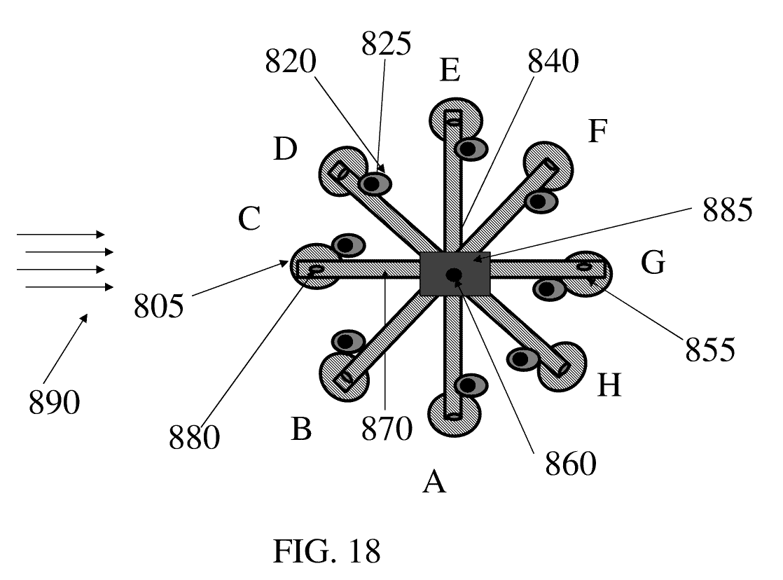

Referring now to FIGS. 17 and 18, a rotary energy harvester is shown generally. One objective of the rotary energy harvester is to use the foil/wings to generate a rotary motion that can be used to drive a rotary generator. Positions A through H are shown only for reference because the foil/wings 805 travel in a complete circle about a central axis 860 located transverse (and preferably vertically) to the direction of fluid flow 890. Frames 870 extend radially from the central axis 860 and are evenly spaced from each other. The foil/wings 805 are connected to the frames 870. The angle of the foil/wings causes lift, which in turn causes frames 870 to revolve around the central axis 860. The device is significantly simpler than the devices of the prior art since the foil/wings do not fight each other during rotation. The cam 820 causes the foil/wings to change direction from position E to position A. This makes the foil/wings 805 located in the downstream half of the rotary energy harvester (the trailing foil/wings) not fight the force generated in the foil/wings 805 located in the upstream half of the rotary energy harvester (the leading foil/wings). If the fluid flow 890 is reversed similar to that found in a tidal basin where the tide comes in and goes out the lift generated by the foil/wings 805 will be in the opposite direction desired. To generate power in both directions of fluid flow 890, the generator input can be reversed by changing the direction of the drive to maintain the lift in the same direction to drive the rotary motion so that it continues to produce power.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A reaction energy harvester, comprising:
a fluid flow path defined by an inflow fluid channel, an outflow fluid channel, and a chamber disposed between said inflow fluid channel and said outflow channel;
a foil/wing transversely mounted in said chamber and being movable in said fluid flow path between a first position and a second position;
at least one counter balancing system cooperatively associated with said foil/wing;
a means for producing an electrical current from a movement of said foil/wing in said fluid flow path;
a battery for charging by said electrical current produced from said means for producing said electrical current; and
means for connecting said battery to an electrical grid.

2. The reaction energy harvester of claim 1, wherein said counter balancing system is a counter weight.

3. The reaction energy harvester of claim 1, wherein said counter balancing system is a foil/wing containing hydraulics, pneumatics, or springs to provide a force suitable for returning said foil/wing to said first position from said second position.

4. The reaction energy harvester of claim 1, wherein said reaction energy harvester is attached to a floating platform.

5. The reaction energy harvester of claim 1, wherein said reaction energy harvester is attached to a non floating platform.

6. The reaction energy harvester of claim 1 wherein a fluid in said fluid flow path is air.

7. The reaction energy harvester of claim 1 wherein a fluid in said fluid flow path is water.

8. The reaction energy harvester of claim 1, wherein said means for producing said electrical current comprises,
a rack movable in response to movement of said foil/wing, and
at least one pinion gear drivable by a movement of said rack, said pinion gear being operably connected to an electrical generator,
wherein driving of said pinion gear operably connected to said electrical generator produces said electrical current.

9. The reaction energy harvester of claim 1, wherein said means for producing said electrical current comprises,
a magnet, and
a coil in operable communication with said magnet,
wherein a movement of said magnet relative to said coil produces said electrical current.

10. A reaction energy harvester for use in a building outflow line, said reaction energy harvester comprising:
a fluid flow path defined by an inflow fluid channel, an outflow fluid channel, and an energy harvester chamber disposed between said inflow fluid channel and said outflow fluid channel;
a foil/wing transversely mounted in said energy harvester chamber and movable between a first position and a second position;
at least one counter balancing system cooperatively associated with said foil/wing;
means for producing an electrical current from a movement of said foil/wing in said fluid flow path;
a battery operably connected to said means for producing said electrical current, said battery being for charging by the electrical current; and
means for connecting said battery to a power grid of a building.

11. The reaction energy harvester of claim 10, wherein said counter balancing system is a counterweight.

12. The reaction energy harvester of claim 10, wherein said counter balancing system is a foil/wing containing hydraulics, pneumatics, or springs to provide a force suitable for returning said foil/wing to said first position from a second position.

13. The reaction energy harvester of claim 10 where the outflow fluid channel is connected to a sewer.

14. The reaction energy harvester of claim 10 where the outflow fluid channel is a roof drain.

15. The reaction energy harvester of claim 10 where the outflow fluid channel is an air conditioning line.

16. A reaction energy harvester, comprising:
a fluid flow path defined by an inflow fluid channel, an outflow fluid channel, and an energy harvester chamber disposed between said inflow fluid channel and said outflow fluid channel;
a foil/wing transversely mounted in said energy harvester chamber so as to receive fluid flow in said fluid flow path;
at least one counter balancing system cooperatively connected to said foil/wing;
means for producing an electrical current from movement of said foil/wing in said fluid flow path;
a reaction chamber for separating water into oxygen and hydrogen using said electrical current;
an outflow means for the oxygen; and
an outflow means for the hydrogen.

17. A reaction energy harvester for harnessing wave action in a body of liquid, comprising:
a fluid flow path defined by an inflow fluid channel, an outflow fluid channel, and an energy harvester chamber disposed between said inflow fluid channel and said outflow fluid channel;
a foil/wing transversely mounted in said energy harvester chamber so that said foil/wing floats on a surface of a fluid level said body of liquid and is movable with changes in said fluid level from a first position to a second position;
at least one counter balancing system capable of returning said foil/wing from said second position to said first position;
means for generating an electrical current based on movement of said foil/wing between said first position and said second position;
a battery for charging by the electrical current from said means for generating said electrical current; and
means for discharging said battery to a power grid.

18. A rotary energy harvester, comprising:
a central axis for being positioned vertically transverse to a direction of fluid flow;
a plurality of frames extending radially from said central axis and being evenly spaced apart from each other; and
a foil/wing operably located on each of said frames;
wherein subjecting said rotary energy harvester to said direction of fluid flow produces movement of each of said foil/wings thereby causing said plurality of frames to rotate about said central axis.

19. The rotary energy harvester of claim 18, wherein said foil/wing is moved by a cam.

20. The rotary energy harvester of claim 19, wherein said cam is connected to a support frame of the foil/wing so as to position the foil/wing to generate lift from the upstream fluid flow.

21. The rotary energy harvester of claim 19, wherein a direction of operation of said motor is reversed when said foil/wing is positioned in a downstream position of said rotary energy harvester relative to said direction of said fluid flow.

22. A floating energy harvester assembly, comprising:
a catamaran for floating on a surface of a flowing liquid; and
an energy harvester attached to said catamaran, said energy harvester being oriented perpendicularly to a current of said flowing liquid and located below a surface of said flowing liquid;
wherein said energy harvester generates power from said current of said flowing liquid.

23. The floating energy harvester assembly of claim 22, wherein said energy harvester comprises,
a foil/wing transversely mounted and movable in said current of said flowing liquid between a first position and a second position;
at least one counter balancing system cooperatively associated with said foil/wing;
means for producing an electrical current from a movement of said foil/wing in said flowing liquid;
a battery for charging by said electrical current produced from said means for producing said electrical current; and
means for connecting said battery to a power grid.

24. The floating energy harvester assembly of claim 23, wherein said means for producing an electrical current comprises,
a rack movable in response to movement of said foil/wing, and
at least one pinion gear drivable by a movement of said rack, said pinion gear being operably connected to an electrical generator,
wherein driving of said pinion gear operably connected to said electrical generator produces said electrical current.

25. The floating energy harvester assembly of claim 23, wherein said means for producing an electrical current comprises,
a magnet, and
a coil in operable communication with said magnet,
wherein a movement of said magnet relative to said coil produces said electrical current.
